(19) United States
(12) Patent Application Publication
(10) Pub. No.: US 2021/0145213 A1
(43) Pub. Date: May 20, 2021

(54) Universal Bracket Assembly for Grill Apparatuses

(71) Applicant: The Big Green Egg, Inc., Atlanta, GA (US)

(72) Inventor: Marco Bogazzi, Kennesaw, GA (US)

(21) Appl. No.: 16/953,965

(22) Filed: Nov. 20, 2020

Related U.S. Application Data
(60) Provisional application No. 62/937,839, filed on Nov. 20, 2019.

(51) Int. Cl. A47J 37/07; F16M 13/02

(52) U.S. Cl. CPC A47J 37/0786; F16M 2200/06; A47J 37/0704; F16M 13/02

(57) ABSTRACT

The present disclosure relates to a bracket assembly for mounting an add-on grill apparatus to a cooking device. The bracket assembly can be adjustable to work with any size cooking device or any size add-on grill apparatus. The bracket assembly includes a mounting bracket and a mounting arm adapted to be coupled to the mounting bracket. The bracket assembly includes first and second ends in which the first end mounts to the cooking device and the second end mounts to the add-on grill apparatus.

### CROSS-REFERENCE TO RELATED APPLICATION

This application claims the benefit of U.S. Provisional Application Ser. No. 62,937,839, filed Nov. 20, 2019, the disclosure of which is hereby incorporated by reference in its entirety.

### BACKGROUND

Cooking devices, such as grills, ovens, or smokers, have increasingly become popular fixtures at outdoor social gatherings. Most cooking devices can be mated with selective accessories or add-ons, such as table tops, to make outdoor cooking more convenient. Cooking devices can often come in a variety of sizes, which may require multiple attachment devices of different sizes to mate an add-on to a cooking device.

There is a need for attachment devices that can be utilized to mount add-ons or accessories to cooking devices irrespective of size.

### SUMMARY OF THE INVENTION

Aspects of the present disclosure relate to a bracket assembly that can be customizable for use with a cooking device. That is, a separate, universal bracket assembly may be utilized with add-on mate for cooking devices. The bracket assembly can have interfaces for attaching to the cooking device. At least two bracket assemblies can be attached to the cooking device for supporting a mate or may not be utilized at all. In one example, the bracket assembly may be selectively moved on the cooking device to be spaced a desired distance apart to complement any cooking device. The configuration is advantageous because it allows the flexibility of using the bracket assembly with a variety of cooking devices and add-on mates without complexity. That is, the bracket assembly can be adjustable to mount on any size cooking device to place an add-on mate as desired. In certain examples, the bracket assembly can be attached to a cooking device by a fastener, although alternatives are possible.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a known cooking device;

FIG. 2 is a perspective view of another example cooking device with a bracket assembly mounted thereon for holding an add-on mate in accordance with principles of the present disclosure;

FIG. 3 is another perspective view of the cooking device of FIG. 2;

FIGS. 4-7 are multiple views of the bracket assembly of FIG. 2 including a mounting bracket and a mounting arm in accordance with the principles of the present disclosure;

FIG. 8 is an exploded view of the bracket assembly of FIG. 4;

FIG. 9 is a perspective view of the mounting bracket of FIG. 4;

FIG. 10 is a perspective view of the mounting arm of FIG. 4; and

FIG. 11 is a side view of the cooking device and bracket assembly of FIG. 2.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Cooking devices such as kamado-style cookers, grills, ovens, or smokers can have various sizes and shapes. Many of these cooking devices can be complemented with add-on mates (e.g., tables, shelves) that are simple and convenient additions to provide working and serving space. The add-on mates can be mounted on sides of a cooking device and can be collapsed down when not in use. Depending on the size of the cooking device, a different size mounting arrangement may be needed to mount the add-on mate to the cooking device. That is, a small cooking device would require a different size mounting arrangement than a larger cooking device. Furthermore, the add-on mates may also be arranged and configured in different sizes to complement a specific cooking device.

One aspect of the present disclosure relates to a universal bracket assembly. The present disclosure describes a bracket assembly that provides a mounting arrangement that can be used to accommodate multiple cooking devices and add-on mates irrespective of size. That is, the universal bracket assembly can be a “one size fits all” design.

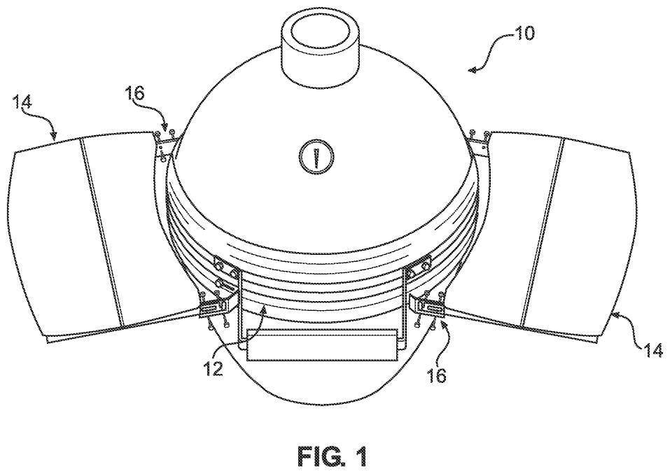

FIG. 1 illustrates a perspective view of a known cooking device 10 (e.g., kamado-style cooker, grill, smoker, oven, etc.) including a ring 12 and add-on mates 14 (e.g., add-on grill apparatuses, grill mates, grill accessories) mounted to the ring 12. The add-on mates 14 are shown mounted to sides of the cooking device 10 via a mounting arrangement 16. The mounting arrangement 16 of the known cooking device 10 may not be adjustable to mount to multiple size cooking devices 10. The add-on mates 14 include a working and servicing area, such as, but not limited to, a table top or side table.

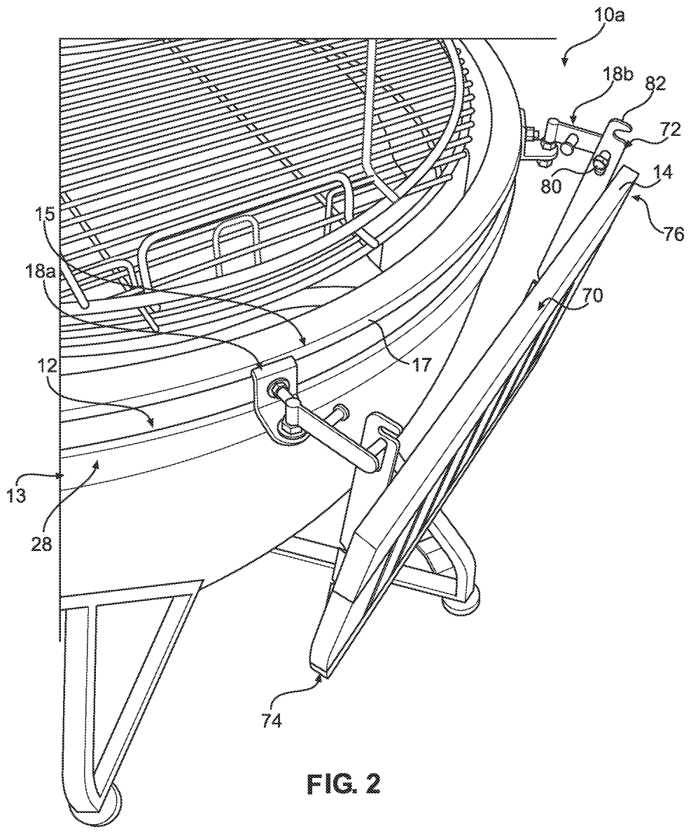

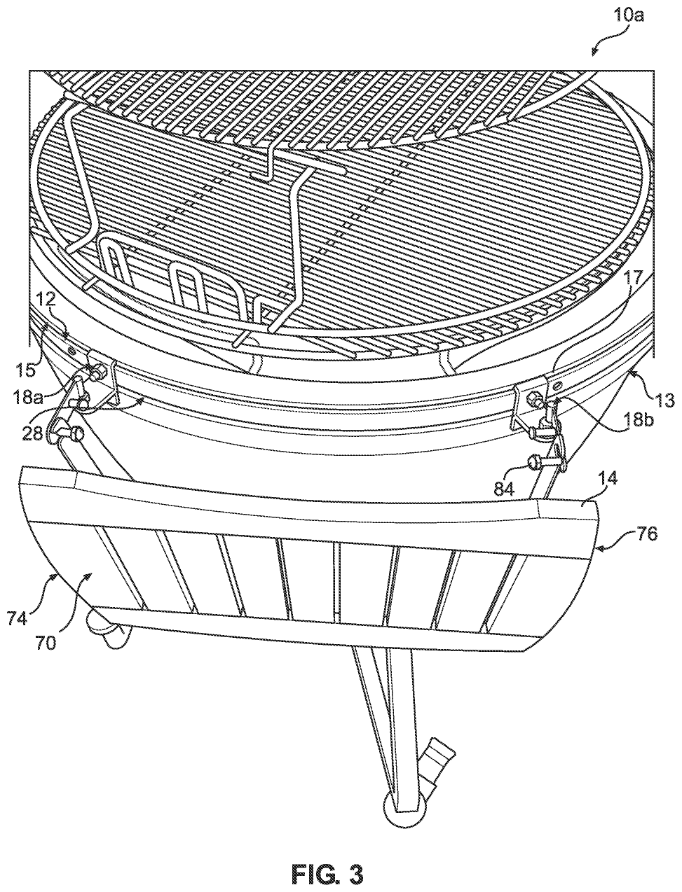

FIGS. 2 and 3 show a cooking device 10a that preferably includes a bottom shell 13 (e.g., base) movably coupled via a conventional hinge mechanism to a lid. As depicted, only a portion of the cooking device 10a is shown, in this case the bottom shell 13. The lid above the bottom shell 13 has been raised or removed. Both the bottom shell 13 and the lid may be formed from steel, other metal alloys, and/or ceramic materials.

The cooking device 10a can include a pair of universal bracket assemblies 18a, 18b in which one end mounts to the add-on mate 14 and the other end mounts to the cooking device 10a, as will be described below. The bracket assemblies 18a, 18b can be spaced apart on the cooking device 10a as desired to attach the add-on mate 14 between the bracket assemblies 18a, 18b. In certain examples, the bracket assemblies 18a, 18b can include receptacles and supports for holding the add-on mate 14. The bracket assemblies 18a, 18b can be adjustable relative to each other on a cooking device such that mounting to different size cooking devices or mates is possible.

The bracket assemblies 18a, 18b can be attached to the ring 12 or directly to the cooking device 10a. In the example depicted, the bracket assemblies 18a, 18b are disposed on the ring 12 positioned on the bottom shell 13 of the cooking device 10a. The bracket assemblies 18a, 18b are arranged and configured to mount the add-on mates 14 to the cooking device 10a. The ring 12 can be attached around a periphery 15 of an upper edge 17 of the bottom shell 13. The ring 12 and the bracket assemblies 18a, 18b may be comprised of a metal material.

Those skilled in the art will appreciate that a conventional installation may require both bracket assemblies 18a, 18b, although alternatives are possible. Naturally, the bracket assemblies 18a, 18b will be mirror images of each other due to their opposite orientation on either side of the cooking device 10a. For the purposes of simplicity, only one of the bracket assemblies 18a, 18b will be described herein.

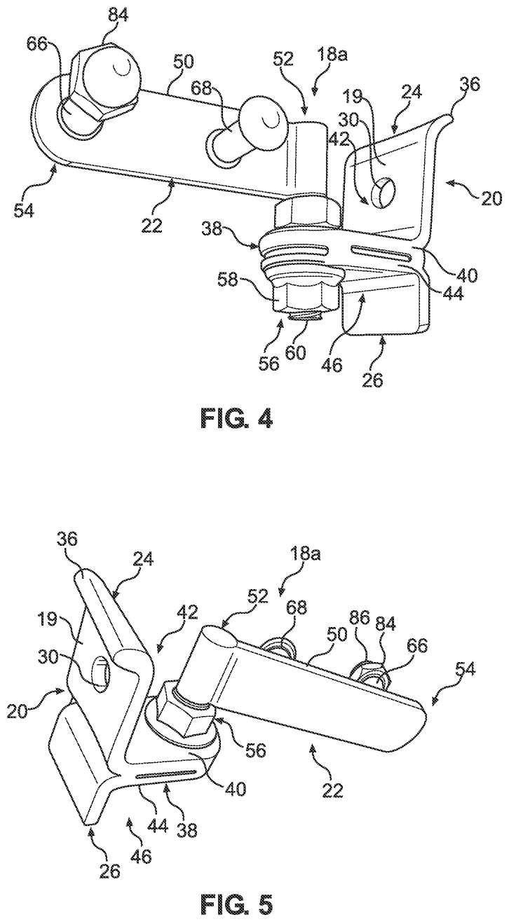

Turning to FIGS. 4-7, perspective views of the bracket assembly 18a is shown. The bracket assembly 18a can include a mounting bracket 20 and a mounting arm 22 that are adapted to mount together.

The mounting bracket 20 can include an upper flange 24 and an opposite, lower flange 26. The upper flange 24 and the lower flange 26 can be oriented parallel to one another. In certain examples, the upper flange 24 can have a length L₁ that is greater than a length L₂ of the lower flange 26, although alternatives are possible. In certain examples, the length L₁ of the upper flange 24 can be at least about 1.5 times greater than the length L₂ of the lower flange 26. In other examples, the length L₁ of the upper flange 24 can be at least about twice as long than the length L₂ of the lower flange 26. When the mounting bracket 20 is mounted on the cooking device 10a, the upper flange 24 can be arranged and configured to mount to the ring 12 and the lower flange 26 can be arranged and configured to rest on a body portion 28 of the cooking device 10a.

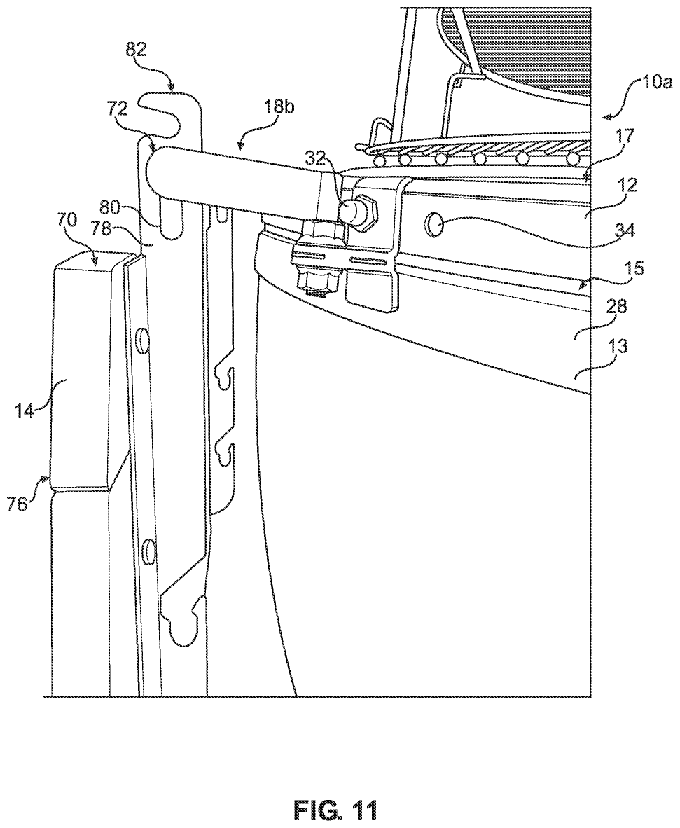

The upper flange 24 can include a main body 19 that defines an opening 30 adapted to receive a fastener 32 (e.g., screws, bolts, rivets, etc.)(see FIG. 11) for anchoring (e.g., securing, attaching, fixing, fastening etc.) the mounting bracket 20 to the ring 12 of the cooking device 10a. That is, when the mounting bracket 20 is mounted on the cooking device 10a, the fastener 30 extends outwardly from the opening 30 to engage an aperture 34 (see FIG. 11) defined in the ring 12 to fasten the mounting bracket 20 to the cooking device 10a. In certain examples, the ring 12 may define a plurality of apertures 34 for selectively positioning the mounting bracket 20 on the cooking device 10.

In certain examples, the upper flange 24 can also include a lip portion 36 that extends in a direction generally perpendicular to the main body 17 of the upper flange 24. When the mounting bracket 20 is fastened to the cooking device 10a, the lip portion 36 can be adapted to extend over at least a portion of the ring 12 to frictionally grip the upper flange 24 against the ring 12. The lip portion 36 can be integrally formed with the upper flange 24.

In certain examples, the mounting bracket 20 can include a fixation member 38 formed by portions of the upper and lower flanges 24, 26. That is, the fixation member 38 can include an upper flange member 40 that extends perpendicular relative to the upper flange 24 to form a first 90° elbow 42. The fixation member 38 can also include a lower flange member 44 that extends perpendicular relative to the lower flange 26 to form a second 90° elbow 46. It is to be understood that varying degrees can be used for the first and second elbows 42, 46. Portions of the upper and lower flange members 40, 44 can be welded together to form the fixation member 38, although alternatives are possible. The upper and lower flange members 40, 44 of the fixation member 38 can be oriented parallel to one another. The fixation member 38 can define a mounting hole 48 (e.g., opening, aperture) therethrough. That is, the mounting hole 48 can extend through both the upper and lower flange members 40, 44.

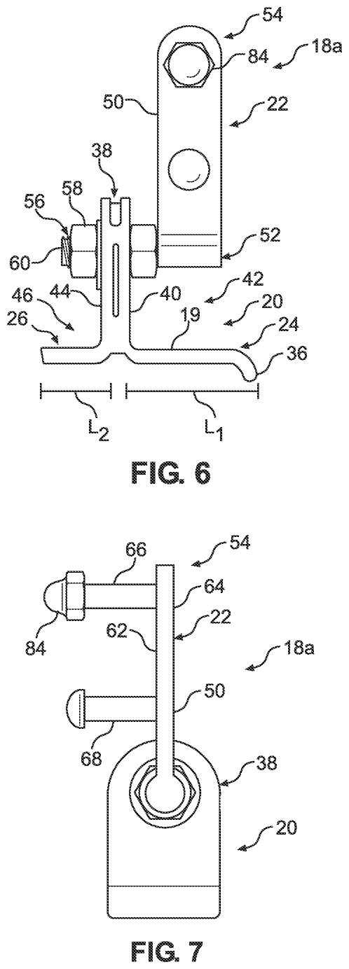

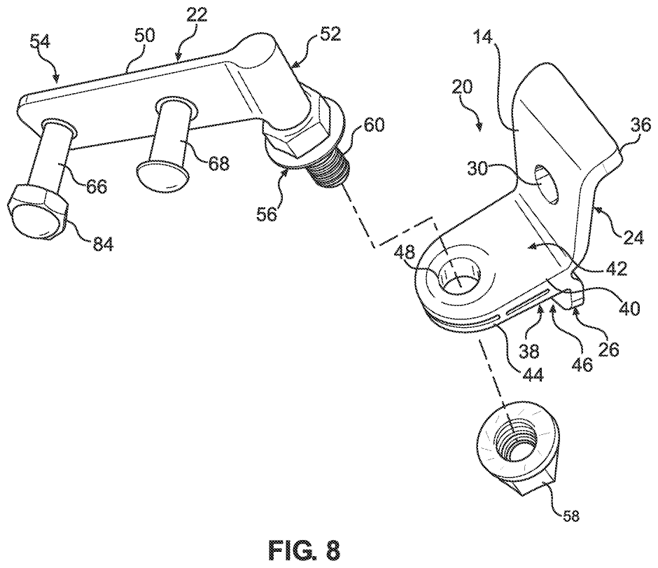

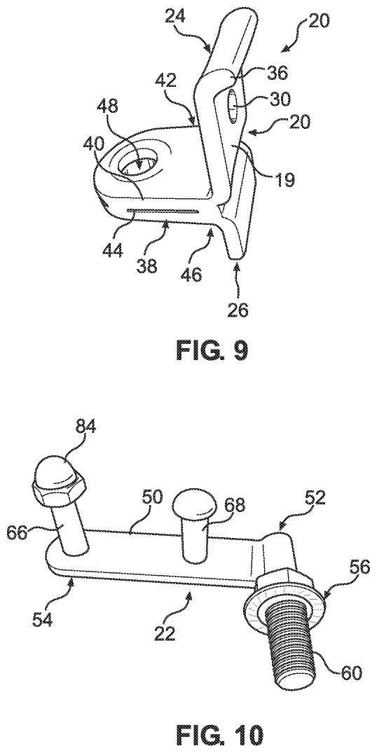

Turning to FIG. 8, an exploded view of the bracket assembly 18a is depicted. The mounting bracket 20 (see FIG. 9) is shown detached from the mounting arm 22 (see FIG. 10). In certain examples, the mounting bracket 20 may be mounted to the cooking device 10a before attaching the mounting arm 22 to the mounting bracket 20, although alternatives are possible. The mounting arm 22 can be used to attach the add-on mate 14 to the cooking device 10a via the mounting bracket 20.

The mounting arm 22 can include a longitudinal body 50 having a first end 52 and an opposite second end 54. The mounting arm 22 can include a stud 56 that can extend perpendicularly relative to the longitudinal body 50 at the first end 52 to form an L-shaped mounting arm 22, although alternatives are possible. In certain examples, the stud 56 can be welded to the longitudinal body 50. When the mounting bracket 20 is coupled to the mounting arm 22, the mounting hole 48 of the fixation member 38 can receive the stud 56 of the mounting arm 22 such that the stud 56 extends radially outwardly therefrom. A nut 58 can be secured on a threaded end 60 of the stud 56 to secure the mounting arm 22 to the mounting bracket 20. In certain examples, a locking pin or other device can be used to secure the mounting bracket 20 to the mounting arm 22.

The longitudinal body 50 of the mounting arm 22 can include opposing first and second sides 62, 64. The longitudinal body 50 can include a first mounting post 66 (e.g., peg) and a second mounting post 68 that extend outwardly from the first side 62 of the longitudinal body 50. In one example, the first and second mounting post 66, 68 define a round profile, although a square or rectangular profile could be utilized, if desired.

The first and second mounting posts 66, 68 can extend outwardly from the first side 62 of the longitudinal body 50 in a direction that is generally perpendicular to the longitudinal body 50 of the mounting arm 22. The first and second mounting posts 66, 68 can be used to attach the mounting arm 22 to the add-on mate 14, as will be described below. In certain examples, the first and second mounting posts 66, 68 can be welded to the longitudinal body 50 of the mounting arm 22.

In the example depicted, the add-on mate 14 includes one or more side tables 70 made, for example, from pressed wood board, although alternatives are possible. In one example, the cooking device 10a includes at least one side table 70. In other examples, the cooking device 10a includes two side tables 70 that are arranged and configured on opposite sides of the cooking device 10a by the bracket assemblies 18a 18b. When attached to the cooking device 10a, the side tables 70 are coupled to the mounting arm 22 which in turn is rigidly coupled to the mounting bracket 20 fastened on the cooking device 10a.

Turning to FIG. 11, the side tables 70 can include table support mounts 72 fastened on opposing sides 74, 76 of the side tables 70. The table support mounts 72 are mountable to the bracket assemblies 18a, 18b, respectively. The table support mounts 72 each include a plate 78 with a slot opening 80 and an engagement hook member 82. The first mounting post 66 can be arranged and configured for positioning the side tables 70 on the cooking device 10a. As depicted, the first mounting post 66 couples the mounting arm 22 to the table support mounts 72 of the side tables 70 via the slot opening 80 defined in the plate 78. In the example depicted, the first mounting post 66 attaches the mounting arm 22 to the table support mounts 72 and a nut 84 is secured on a threaded end 86 (see FIG. 5) of the first mounting post 66. It will be appreciated that other fasteners may be used to extend through the slot opening 80 of the plate 78 to secure the side tables 70 to the bracket assemblies 18a, 18b.

The first mounting post 66 can travel within the slot opening 80 to allow the side table 70 to be movable between a raised position (see FIG. 1) and a collapsed position (see FIG. 3). When the side table 70 is in the raised position, the engagement hook member 82 is configured to capture the second mounting post 68 to support the side table 70 in a horizontal position relative to the cooking device 10a. When the side table 70 is raised, the lower flange 26 provides the support and stability needed to keep the side table 70 in the horizontal position. When the side table 70 is mounted, the lower flange 26 can rest against the bottom shell 13 of the cooking device 10a such that less stress is placed on the fastener 32 in the upper flange 24. The first and second mounting posts 66, 68 allow for quick and easy installation of the side table 70 via the table support mounts 72.

From the forgoing detailed description, it will be evident that modifications and variations can be made without departing from the spirit and scope of the disclosure.

What is claimed is:

1. A bracket assembly for mounting a grill apparatus on a grill, the grill including a base having a ring positioned around a periphery of an upper edge of the base, the ring defining a plurality of receptacles, the bracket assembly, comprising:
a mounting bracket; and
a mounting arm adapted to be coupled to the mounting bracket;
the mounting bracket including an upper flange, a lower flange, and a fixation member, wherein the upper flange defines an opening for receiving a fastener, wherein the fixation member defines a mounting hole therethrough, wherein the lower flange extends in a direction opposite to the upper flange, and wherein the lower flange is oriented parallel to the upper flange and the fixation member is oriented perpendicularly to the upper and lower flanges;
the mounting arm having a longitudinal body, the mounting arm including a stud, a first mounting post, and a second mounting post, wherein the longitudinal body has first and second opposing ends, wherein the stud extends perpendicularly relative to the longitudinal body at the first end, and wherein the first and second mounting posts extend outwardly from the longitudinal body in a direction that is generally perpendicular to the longitudinal body of the mounting arm;
wherein, when the mounting bracket is mounted to the grill, the fastener in the opening of the upper flange is received within one of the plurality of receptacles of the ring; and
wherein, when the mounting arm is coupled to the mounting bracket, the mounting hole of the fixation member receives the stud of the mounting arm which is secured therein with a nut.

2. The bracket assembly of claim 1, wherein the upper flange includes a lip extending in a direction generally perpendicular to the upper flange, the lip being adapted to extend over at least a portion of the ring.

3. The bracket assembly of claim 1, wherein the fixation member includes an upper flange member that extends perpendicular relative to the upper flange and a lower flange member that extends perpendicular relative to the lower flange.

4. The bracket assembly of claim 3, wherein the upper flange member extends parallel to the lower flange member, the upper and lower flange members together defining the mounting hole.

5. The bracket assembly of claim 1, wherein the stud and the first and second mounting posts are welded to the longitudinal body of the mounting arm.

6. The bracket assembly of claim 1, wherein the upper flange has a length that is greater than a length of the lower flange.

7. The bracket assembly of claim 1, wherein the grill apparatus includes a working and servicing area.

8. The bracket assembly of claim 7, wherein the working and servicing area is a table top.

9. The bracket assembly of claim 1, wherein the grill apparatus includes at least two table support mounts that each define an elongated slot and an engagement hook member.

10. The bracket assembly of claim 9, wherein the first mounting post of the mounting arm is positioned adjacent the second end of the longitudinal body, the elongated slot being adapted to receive the first mounting post when the grill apparatus is mounted on the mounting arm.

11. The bracket assembly of claim 9, wherein the second mounting post of the mounting arm is positioned adjacent the stud at the first end of the longitudinal body, wherein when the grill apparatus is mounted and raised relative to the cooking device, the engagement hook member is adapted to capture the second mounting post for supporting the grill apparatus in a horizontal position.

12. A bracket assembly for mounting an add-on grill apparatus to a cooking device, the bracket assembly comprising:
a mounting bracket including an upper flange that defines an opening, a lower flange oriented parallel relative to the upper flange, and a fixation member, the fixation member including an upper flange member that extends perpendicularly relative to the upper flange and a lower flange member that extends perpendicularly relative to the lower flange, wherein the upper flange member extends parallel to the lower flange member and the upper and lower flange members together define a mounting hole therethrough; and
a mounting arm adapted to be coupled to the mounting bracket, the mounting arm having a longitudinal body, the mounting arm including a stud, a first mounting post, and a second mounting post, wherein the longitudinal body has first and second opposing ends such that the stud extends perpendicularly relative to the longitudinal body at the first end, and wherein the first and second mounting posts extend outwardly from the longitudinal body in a direction that is generally perpendicular to the longitudinal body;
wherein when the mounting bracket is mounted to the mounting arm, the mounting hole of the fixation member is adapted to receive the stud of the mounting arm which is secured therein with a nut; and
wherein the mounting bracket is adapted to be attached to the cooking device and the mounting arm is adapted to be attached to the add-on grill apparatus.

13. The bracket assembly of claim 12, wherein the upper flange includes a lip extending in a direction generally perpendicular to the upper flange for frictionally gripping the mounting bracket against the cooking device.

14. The bracket assembly of claim 12, wherein the add-on grill apparatus includes a working and servicing area.

15. The bracket assembly of claim 14, wherein the working and servicing area is a table top.

16. The bracket assembly of claim 12, wherein the add-on grill apparatus includes at least two table support mounts that each define an elongated slot and an engagement hook member.

17. The bracket assembly of claim 16, wherein the first mounting post of the mounting arm is positioned adjacent the second end of the longitudinal body, the elongated slot being adapted to receive the first mounting post when the add-on grill apparatus is mounted on the mounting arm.

18. The bracket assembly of claim 16, wherein the second mounting post of the mounting arm is positioned adjacent the stud at the first end of the longitudinal body, wherein when the add-on grill apparatus is mounted and raised relative to the cooking device, the engagement hook member is adapted to capture the second mounting post for supporting the add-on grill apparatus in a horizontal position.

19. A method for mounting an add-on grill apparatus to a cooking device comprising the add-on grill apparatus including table support mounts that include an elongated slot and engagement hook member, the method comprising:
providing a bracket assembly including a mounting bracket and a mounting arm, the mounting bracket including an upper flange, a lower flange, and a fixation member, wherein the upper flange defines an opening, wherein the fixation member defines a mounting hole therethrough, wherein the mounting arm includes a stud, a first mounting post, and a second mounting post;
securing the mounting bracket to the cooking device via the upper flange;
mounting the stud of the mounting arm into the mounting hole of the fixation member to couple the mounting bracket with the mounting arm; and
fixing the add-on grill apparatus to the mounting arm via the first and second mounting posts.

20. The method of claim 19, wherein the step of fixing the add-on grill apparatus to the mounting arm includes inserting the first mounting post within the elongated slot to be secured thereto and capturing the second mounting post via the engagement hook member of the table support mounts.
